(19) United States
(12) Patent Application Publication
(10) Pub. No.: US 2011/0235748 A1
(43) Pub. Date: Sep. 29, 2011

(54) ACTIVE ANTENNA ARRAY HAVING ANALOGUE TRANSMITTER LINEARISATION AND A METHOD FOR PREDISTORTION OF RADIO SIGNALS

(76) Inventor: Peter Kenington, Chepstow (GB)

(21) Appl. No.: 12/732,613

(22) Filed: Mar. 26, 2010

(51) Int. Cl. H04L 25/03; H04L 1/02

(52) U.S. Cl. 375/296; 375/347

(57) ABSTRACT

An active antenna array comprises: a digital signal processor connected to a plurality of digital-to-analogue conversion blocks; a plurality of antenna elements; a plurality of transmission paths, whereby an individual one of the plurality of transmission paths is connected between an individual one of the plurality of digital-to-analogue conversion blocks and an individual one of the plurality of antenna elements, whereby an individual one of the plurality of transmission paths comprises a predistorter and a coupler; and a plurality of feedback paths connected between an individual one of the couplers and an individual one of the predistorters, wherein an individual one of the plurality of feedback paths comprises a predistorter coefficient calculation unit. A method for predistorting radio signals is also disclosed.

### CROSS-REFERENCE TO OTHER APPLICATIONS

This application is related to concurrently filed U.S. patent application Ser. No. ______ “Active Antenna Array having Analogue Transmitter Linearisation and a Method for Predistortion of Radio Signals” (Attorney Docket No. 4424-P05035US0) and U.S. patent application Ser. No. ______ “Active Antenna Array having a Single DPD Lineariser and a Method for Predistortion of Radio Signals” (Attorney Docket No. 4424-P05034US0) as well as U.S. patent application Ser. No. 12/648,028 filed on 28 Dec. 2009.

The entire contents of the applications are incorporated herein by reference.

### FIELD OF THE INVENTION

The field of the invention relates to an active antenna array and a method for predistortion of a plurality of transmit paths in the active antenna array.

### BACKGROUND OF THE INVENTION

The use of mobile communications networks has increased over the last decade. Operators of the mobile communications networks have increased the number of base stations in order to meet an increased demand for service by users of the mobile communications networks. The operators of the mobile communications network wish to reduce the running costs of the base station. One option to do this is to implement a radio system as an antenna-embedded radio forming an active antenna array. Many of the components of the antenna-embedded radio may be implemented on one or more chips.

Nowadays antenna arrays are used in the field of mobile communications systems in order to reduce power transmitted to a handset of a customer and thereby increase the efficiency of the base station, i.e. the radio station. The radio station typically comprises a plurality of antenna elements, i.e. an antenna array adapted for transceiving a payload signal. Typically the radio station comprises a plurality of transmit paths and receive paths. Each of the transmit paths and receive paths are terminated by one of the antenna elements. The plurality of the antenna elements used in the radio station typically allows steering of a beam transmitted by the antenna array. The steering of the beam includes but is not limited to at least one of: detection of direction of arrival (DOA), beam forming, down tilting and beam diversity. These techniques of beam steering are well-known in the art.

The code sharing and time division strategies as well as the beam steering rely on the radio station and the antenna array to transmit and receive within well defined limits set by communication standards. The communications standards typically provide a plurality of channels or frequency bands useable for an uplink communication from the handset to the radio station as well as for a downlink communication from the radio station to the handset. In order to comply with the communication standards it is of interest to reduce so called out of band emissions, i.e. transmission out of a communication frequency band or channel as defined by the communication standards.

For the transmission of the payload signal the base station comprises an amplifier within the transmit paths of the radio station. Typically, each individual one of the transmit paths comprises an individual one of the amplifiers. The amplifier typically introduces nonlinearities into the transmit paths. The nonlinearities introduced by the amplifier affect transfer characteristics of the transmit paths. The nonlinearities introduced by the amplifier distort the payload signal relayed by the radio station as a transmit signal along the transmit paths.

The transfer characteristics of the device describe how the input signal(s) generate the output signal. It is known in the art that the transfer characteristics of a nonlinear device, for example a diode or the amplifier, are generally nonlinear.

The concept of predistortion uses the output signal of the device, for example from the amplifier, for correcting the nonlinear transfer characteristics. The output signal is compared to the input signal by means of feedback and from this comparison correction coefficients are generated which are used to form or update an “inverse distortion” which is added and/or multiplied to the input signal in order to linearise the transfer characteristics of the device. The nonlinear transfer characteristics of the amplifier can be corrected by carefully adjusting the predistortion.

To apply a correct amount of the predistortion to the amplifier it is of interest to know the distortions or nonlinearities introduced by the amplifier. This is commonly achieved by the feedback of the transmit signal to a predistorter. The predistorter is adapted to compare the transmitted signal with a signal prior to amplification in order to determine the distortions introduced by the amplifier. The signal prior to amplification is, for example, the payload signal.

The concept of the predistortion has been explained in the above description in terms of correcting the transfer characteristics with respect to the amplitude of the tranmit signal. It is understood that predistortion may alternatively and/or additionally correct for nonlinearities with respect to a phase of the input signal and the output signal.

The nonlinearities of the transfer characteristics of the complete transmit path from a digital signal processor to the antenna element are typically dominated by the nonlinearities in the transfer characteristics of the amplifier. It is therefore often sufficient to correct for the nonlinearities of the amplifier.

### SUMMARY OF THE INVENTION

This disclosure discloses an active antenna array which comprises a digital signal processor connected to a plurality of digital-to-analogue conversion blocks; a plurality of antenna elements; a plurality of transmission paths, whereby an individual one of the plurality of transmission paths is connected between an individual one of the plurality of digital-to-analogue conversion blocks and an individual one of the plurality of antenna elements, whereby an individual one of the plurality of transmission paths comprises a predistorter and a coupler. A plurality of feedback paths is connected between an individual one of the couplers and an individual one of the predistorters. An individual one of the plurality of feedback paths comprises a predistorter coefficient calculation unit.

In one aspect of the invention, the active antenna array comprises a distortion detection unit configured to detect a level of residual distortion in an output signal on an individual one of the plurality of transmission paths, wherein the distorter detection unit is connected to the predistorter coefficient calculation unit.

The digital to analogue conversion block may be one of a digital-to-analogue converter, a delta-sigma digital-to-analogue converter or a pair of digital-to-analogue converters supplying I & Q signals.

In another aspect of the invention, the active antenna array comprises a predistorter control system for controlling the predistorter.

The predistorter control system may comprise at least one of an amplitude controller and a phase controller. The amplitude controller may be adapted to control an amplitude of at least one distortion signal component emanating from an intermodulation product generating non-linearity. The phase controller may be adapted to control a phase at least one distortion signal component emanating from an intermodulation product generating non-linearity.

In another aspect of the invention, the predistorter comprises a splitter and decomposition system adapted for decomposing an input signal into at least two distortion signal components.

The decomposition system may comprise at least one of an analogue multiplier and of a splitter.

In yet another aspect of the invention, the predistorter further comprises a summer for adding the at least two distortion signal components.

The disclosure also teaches a method for predistortion of radio signals comprising predistorting one or more of a plurality of analogue payload signals, thereby obtaining at least one predistorted payload signal, amplifying the at least one predistorted payload signal, extracting a portion of the at least one predistorted payload signal as a feedback signal, and adapting the predistorting of the analogue payload signal by comparing the feedback signal with at least one of the one or more of the plurality of analogue payload signals.

In one aspect of the disclosure, the method for predistortion of radio signals comprises detecting a level of residual distortion in an output signal on an individual one of the plurality of transmission paths.

In another aspect of the disclosure, the method for predistortion of radio signals further comprises iteratively detecting a level of residual distortion in an output signal on an individual one of the plurality of transmission path.

The output signal may comprise at least one distortion signal component.

The method for predistortion of radio signals may further comprise setting at least one of an amplitude controller and a phase controller in order to reduce the detected level of the residual distortion.

The disclosure also teaches a computer program product comprising a non-transitory computer-usable medium having control logic stored therein for causing a computer to manufacture an active antenna array for a mobile communications network, the active array antenna comprising a digital signal processor connected to a plurality of digital-to-analogue conversion blocks; a plurality of antenna elements; a plurality of transmission paths, whereby an individual one of the plurality of transmission paths is connected between an individual one of the plurality of digital-to-analogue conversion blocks and an individual one of the plurality of antenna elements, whereby an individual one of the plurality of transmission paths comprises a predistorter and a coupler; a plurality of feedback paths connected between an individual one of the couplers and an individual one of the predistorters, wherein an individual one of the plurality of feedback paths comprises a predistorter coefficient calculation unit.

In a further aspect of the invention, a computer program product is disclosed which comprises a non-transitory computer-usable medium having control logic stored therein for causing an active antenna to execute a method for receiving a plurality of individual radio signals comprising: first computer readable code means for predistorting one or more of a plurality of analogue payload signals, thereby obtaining at least one predistorted payload signal; second computer readable code means for amplifying the at least one predistorted payload signal; third computer readable code means for extracting a portion of one or more of the at least one predistorted payload signal as a feedback signal; fourth computer readable control means for adapting the predistorting of the one or more of the plurality of analogue payload signals by comparing the feedback signal with at least one of the one or more of the plurality of analogue payload signals.

### DESCRIPTION OF THE FIGS.

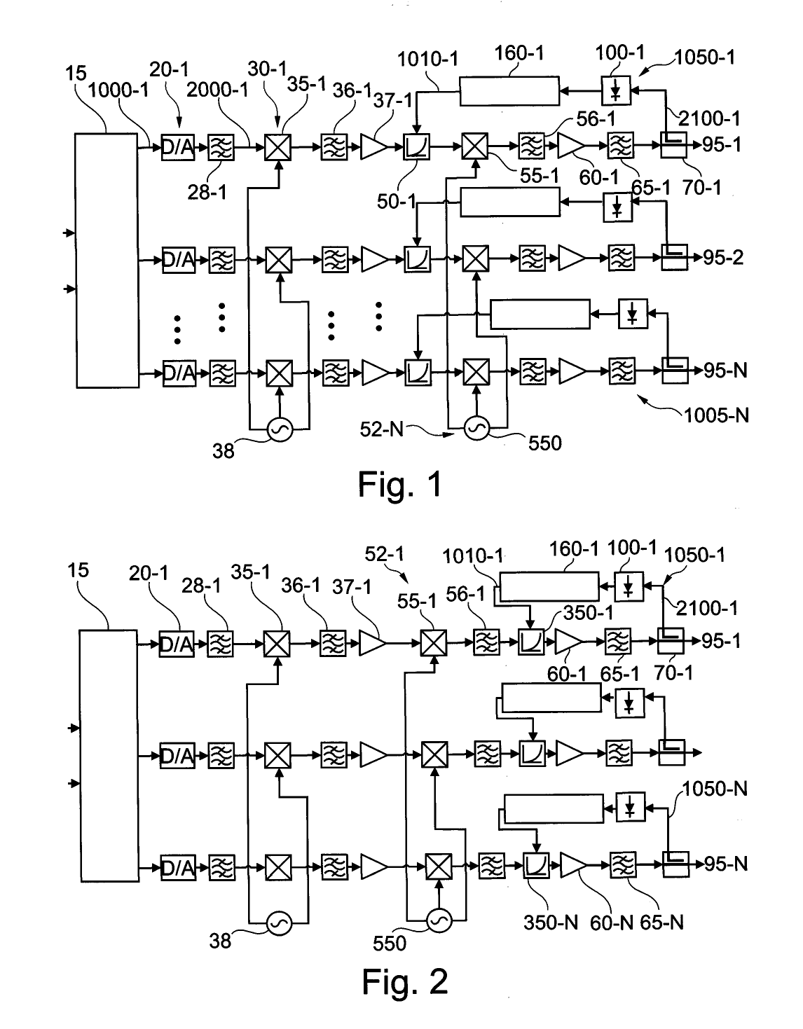

FIG. 1 shows a first aspect of an active array antenna according to the present disclosure.

FIG. 2 shows a distortion detection unit that can be used in one aspect of the disclosure

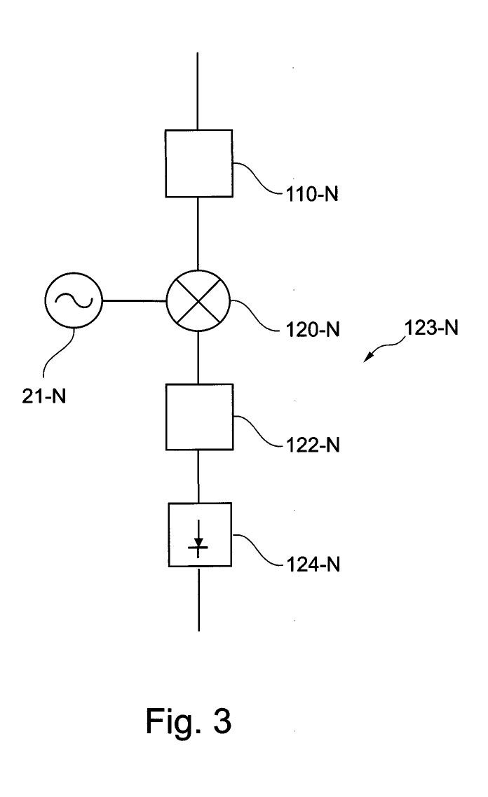

FIG. 3 shows a further aspect of the active array antenna according to the present disclosure.

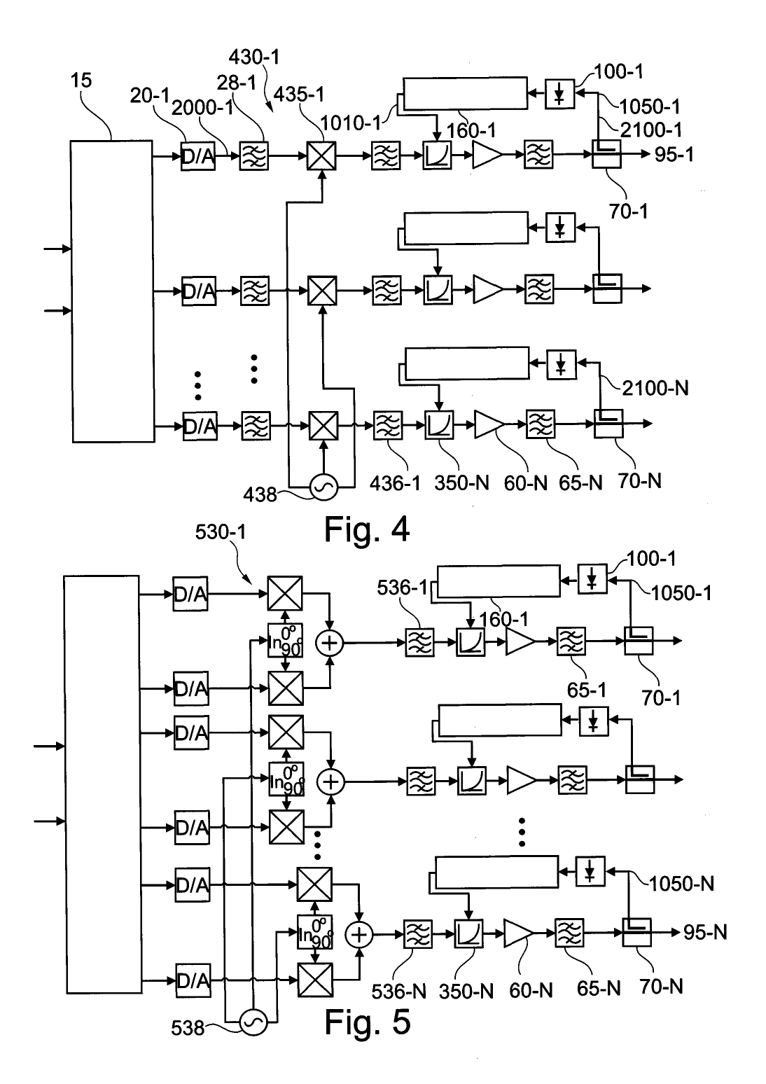

FIG. 4 shows a further aspect of the active array antenna according to the present disclosure.

FIG. 5 shows a further aspect of the active array antenna according to the present disclosure.

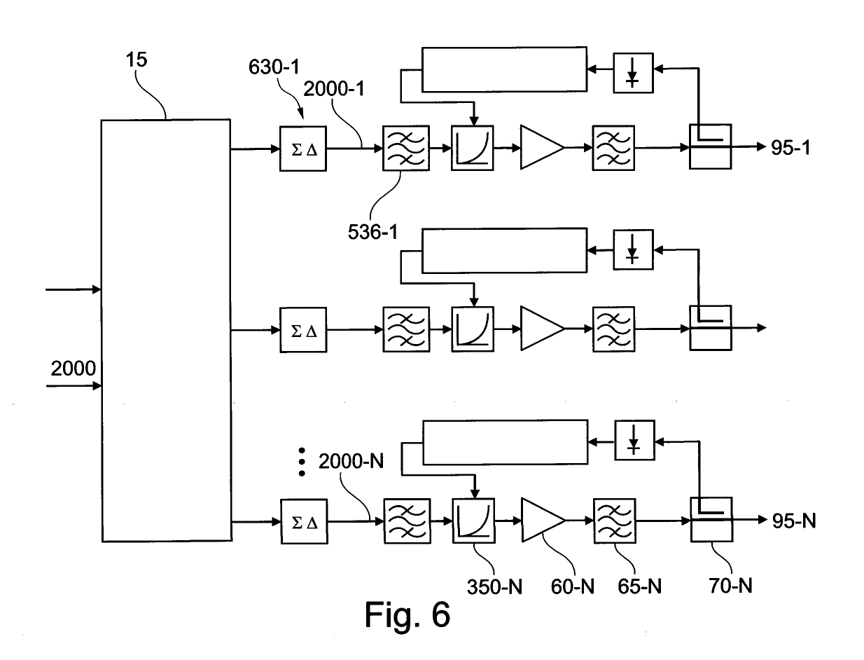

FIG. 6 shows a further aspect of the active array antenna according to the present disclosure

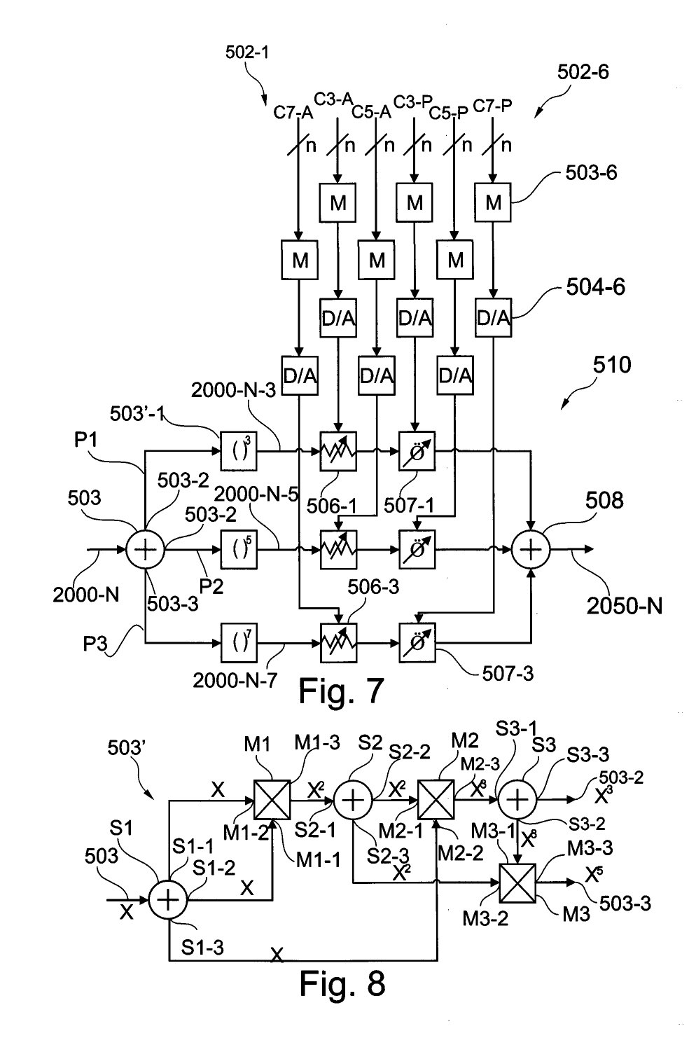

FIG. 7 shows an example of polynomial predistorter that can be used in one aspect of the disclosure.

FIG. 8 shows detailed view of how the third and fifth order non-linearities shown in FIG. 7 could be realized in one aspect of the disclosure.

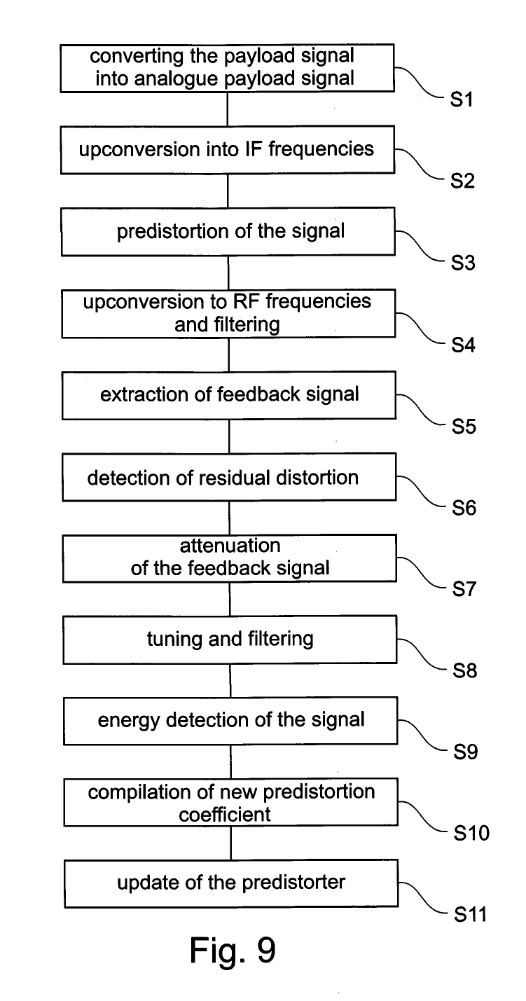

FIG. 9. shows a method for linearising a payload signal according to the present disclosure.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature or features of a different aspect or aspects and/or embodiments of the invention.

FIG. 1 shows a first aspect of an active antenna array 1 according to the present disclosure. A digital signal processor (DSP) 15 receives and processes a payload signal 2000.

The payload signal 2000 typically comprises an in phase portion (I) and an out of phase portion, i.e. a quadrature portion (Q). The digital formats for the payload signal 2000 in an (I, Q) format are known in the art and will not be explained any further.

The active antenna array 1 as shown in FIG. 1 comprises at least one transmit path 1000-1, 1000-2, . . . , 1000-N. There are three different transmit paths 1000-1, 1000-2, . . . , 1000-N displayed within FIG. 1. It will however be appreciated by the person skilled in the art that the number of transmit paths 1000-1, 1000-2, . . . , 1000-N can be changed. In a typical implementation there will be eight or sixteen transmit paths, but this is not limiting of the invention. Each one of the transmit paths 1000-1, 1000-2, . . . , 1000-N is terminated by an antenna element 95-1, 95-2, . . . , 95-N.

In a transmit path 1000-1, 1000-2, . . . , 1000-N the payload signal 2000 is processed by the digital signal processor 15, for example undergoing filtering, upconversion, crest factor reduction and beamforming processing, prior to forwarding to a digital-to-analogue conversion block 20-1, 20-2, . . . , 20-N adapted to convert the payload signal 2000 into an analogue payload signal 2000-1, 2000-2, . . . , 2000-N as a transmit signal. The analogue payload signal 2000-1, 2000-2, . . . , 2000-N may be provided as pairs of amplitude and phase values (A, P). The payload signal 2000 is not changed by the selected form of the payload signal 2000 i.e. (I,Q) or pairs of phase and amplitude (A, P).

The digital-to-analogue conversion block 20-1, 20-2, . . . , 20-N may comprise conventional digital-to-analogue converters 20-1, 20-2, . . . , 20-N. Alternately, the digital-to-analogue conversion block 20-1, 20-2, . . . , 20-N may be in the form of delta-sigma digital-to-analogue converters.

The analogue payload signal 2000-1, 2000-2, . . . , 2000-N is passed to a transmission path 1005-1, 1005-2, . . . , 1005-N. Each one of the transmission paths 1005-1, 1005-2, . . . , 1005-N is connected between a digital-to-analogue conversion block 20-1, 20-2, . . . , 20-N and an antenna element 95-1, 95-2, . . . , 95-N.

The transmission paths 1005-1, 1005-2, . . . , 1005-N comprises a first filter 28-1, 28-2, . . . , 28-N. The first filter 28-1, 28-2, . . ., 28-N may be any filter adapted to appropriately filter the analogue payload signal 2000-1, 2000-2, . . . , 2000-N leaving the digital-to-analogue conversion block 20-1, 20-2, . . . , 20-N after conversion of the payload signal 2000 into an analogue form. Typically, the first filter 28-1, 28-2, . . . , 28-N comprises a band pass filter. The first filter 28-1, 28-2, . . . , 28-N allows the analogue payload signal 2000-1, 2000-2, . . . , 2000-N to pass the first filter 28-1, 28-2, . . . , 28-N in a group of frequency bands or channels as defined by the communication standard, such as for example 3GPP. The purpose of the first filter 28-1, 28-2, . . . , 28-N is to remove unwanted products from the digital to analogue conversion process, such as noise or spurious signals.

The output of the first filter 28-1, 28-2, . . . , 28-N is passed to an up-conversion block 30-1, 30-2, . . . ,30-N. The up-conversion block 30-1, 30-2, . . . ,30-N is adapted for up-converting the analogue payload signal 2000-1, 2000-2, . . . , 2000-N. The up-conversion block 30-1, 30-2, . . . ,30-N comprises an up-mixer 35-1, 35-2, . . . , 35-N along with a filter 36-1, 36-2, . . . , 36-N. The up mixers 35-1, 35-2, . . . , 35-N are known in the art and will not be discussed further within this disclosure. The up-conversion block 30-1, 30-2, . . . ,30-N comprises a local oscillator input port and this input port receives a local oscillator signal from a local oscillator 38. Three signal up-conversion blocks 30-1, 30-2, . . . ,30-N are shown in FIG. 1, all of which are connected to a single local oscillator 38. Having a single local oscillator 38 ensures that the analogue payload signals 2000-1, . . . , 200-N on each one of the transmission paths transmission paths 1005-1, 1005-2, . . . , 1005-N is up-converted coherently.

The output of the up-conversion block 30-1, 30-2, . . . , 30-N, is amplified in an amplifier 37-1, 37-2, . . . , 37-N and passed to an analogue predistorter 50-1, 50-2, . . . , 50-N. The analogue predistorter 50-1, 50-2, . . . , 50-N is adapted to impose at least one predistortion onto the analogue payload signal 2000-1, 2000-2, . . . , 2000-N thus forming the predistorted payload signal. There are three analogue predistorters 50-1, 50-2, . . . , 50-N and three predistorted payload signals shown in FIG. 1. Any other number of the predistortions and/or predistorted payload signals is conceivable. The predistorted payload signals are relayed along the transmission paths 1005-1, 1005-2, . . . , 1005-N as transmit signals.

In the aspect of the invention shown in FIG. 1, the up-conversion block 30-1, 30-2, . . . , 30-N is adapted to convert the analogue payload signal 2000-1, 2000-2, . . . , 2000-N into an intermediate frequency payload signal and the analogue predistorter 50-1, 50-2, . . . , 50-N is adapted to work in the intermediate frequency range.

One of the analogue predistorters 50-1, 50-2, . . . , 50-N is provided for each one the transmission paths 1005-1, 1005-2, . . . , 1005-N. The analogue predistorters 50-1, 50-2, . . . , 50-N enable the individual linearization of each one of the transmission paths 1005-1, 1005-2, . . . , 1005-N to be undertaken.

In FIG. 1, the output of the analogue predistorter 50-1, 50-2, . . . , 50-N is passed into a second up-conversion block 52-1, 52-2, . . . , 52-N. The second up-conversion block 52-1, 52-2, . . . , 52-N is adapted to convert the predistorted payload signal 2050 from the intermediate frequency range to an RF frequency range. Each one of the up-conversion blocks 52-1, 52-2, . . . , 52-N comprises an up-mixer 55-1, 55-2, . . . , 55-N along with a filter 56-1, 56-2, . . . , 56-N. The up-mixers 55-1, 55-2, . . . , 55-N are known in the art and will not be discussed further within this disclosure. The up-conversion block 52-1, 52-2, . . . , 52-N receives a local oscillator signal from the local oscillator 550. Three signal up-conversion blocks 52-1, 52-2, . . . , 52-N are shown in FIG. 1, all of which are connected to a single local oscillator 550. Having a single local oscillator 550 ensures that the up-converted payload signal on each one of the transmission paths 1005-1, 1005-2, . . . , 1005-N is up-converted coherently.

FIG. 1 shows an active array antenna with a transmission path 1005-1, 1005-2, . . . , 1005-N comprising two up-conversion blocks 30-1, 30-2, . . . ,30-N and 52-1, 52-2, . . . , 52-N. However, it will be appreciated that the present invention should not be limited to a given number of up-conversion blocks. There may be transmission paths 1005-1, 1005-2, . . . , 1005-N with no up-conversion blocks. Alternately, there may be transmission paths 1005-1, 1005-2, . . . , 1005-N with one or more up-conversion blocks 30-1, 30-2, . . . ,30-N and 52-1, 52-2, . . . , 52-N, depending on the active antenna array requirements.

The transmission path 1005-1, 1005-2, . . . , 1005-N further comprises an amplifier 60-1, 60-2, . . . , 60-N as well as a filter 65-1, 65-2 . . . , 65-N and a coupler 70-1, . . . , 70-N. The transfer characteristics of the amplifiers 60-1, . . . , 60-N are typically designed to be as identical as possible for each one of the transmission paths 1005-1, 1005-2, . . . , 1005-N. Typically a group of the amplifiers 60-1, 60-2, . . . , 60-N is fabricated in a single batch. The use of the amplifiers 60-1, 60-2, . . . , 60-N belonging to the single batch increases the likelihood of the amplifiers 60-1, 60-2, . . . , 60-N having substantially identical characteristics. This is most notably the case if the amplifiers 60-1, 60-2, . . . , 60-N are fabricated using monolithic semiconductor, hybrid or integrated circuit techniques.

The filter 65-1, 65-2, . . . , 65-N may be any filter adapted to appropriately filter the up-converted transmit signal leaving the amplifier 60-1, 60-2, . . . , 60-N after an amplification of the predistorted payload signal. Typically, the filter 65-1, 65-2, . . . , 65-N comprises a band pass filter to remove out of band signals and it may form part of a duplexer arrangement, with the receive filtering aspects not shown in FIG. 1. The filter 65-1, 65-2, . . . , 65-N allows the up-converted transmit signal to pass the filter 65-1, 65-2, . . . , 65-N in a group of frequency bands or channels as defined by the communication standards of 3GPP.

The coupler 70-1, 70-2, . . . , 70-N is adapted to extract a portion of the upconverted transmit signal as a feedback signal 2100-1, 2100-2, . . . , 2100-N out of the transmission path 1005-1, 1005-2, . . . , 1005-N. The coupler 70-1, 70-2, . . . , 70-N is known in the art and may, for example, comprise a circulator or a directional coupler. Obviously any other form of coupler 70-1, 70-2, . . . , 70-N is appropriate for use with the present disclosure, provided the coupler 70-1, 70-2, . . . , 70-N allows the extraction of a feedback signal 2100-1, 2100-2, . . . , 2100-N out of the upconverted transmit signal. The feedback signal 2100-1, 2100-2, . . . , 2100-N is passed to a combiner 100.

The feedback signal 2100-1, 2100-2, . . . , 2100-N is fed into a feedback path 1050-1, 1050-2, . . . , 1050-N leading from the coupler 70-1, 70-2, . . . , 70N to a predistortion coefficient calculation unit 160-1, 160-2, . . . , 160-N of the predistorter 50-1, . . . , 50-N.

Individual analogue feedback paths 1050-1, 1050-2, . . . , 1050-N are contemplated for each individual one of the transmission paths 1005-1, 1005-2, . . . , 1005-N. Each feedback signal 2100-1, 2100-2, . . . , 2100-N is a representation of the nonlinearities accumulated along an individual one of the transmit paths 1005-1, 1005-2, . . . , 1005-N.

The feedback paths 1050-1, 1050-2, . . . , 1050-N comprise a distortion detection unit 100-1, 100-2, . . . , 100-N. The distortion detection unit 100-1, 100-2, . . . , 100-N is configured to detect a level of residual distortion in an output signal on an individual one of the plurality of transmission paths 1005-1, 1005-2, . . . , 1005-N, as will be described with reference to FIG. 2.

Referring to FIG. 1, the output of the distortion detection unit 100-1, 100-2, . . . , 100-N is passed to a coefficient calculation unit 160-1, 160-2, . . . 160-N for processing. The predistortion coefficient calculation unit 160-N is adapted to update the predistortions imposed onto the analogue payload signal 2000-1, 2000-2, . . . , 2000-N for forming the predistorted payload signal 2050-1, 2050-2, . . . , 2050-N.

The predistortions may be stored as a number in a lookup table or as a set of polynomial coefficients describing the nonlinearities of the predistortions. The predistortion coefficient calculation unit 160-1, 160-2, . . . 160-N is adapted to compare the feedback signals 2100-1, 2100-2, . . . , 2100-N with the analogue payload signal 2000-1, 2000-2, . . . , 2000-N. Subsequently, the predistortion coefficient calculation unit 160-1, 160-2, . . . 160-N is adapted to determine the nonlinearities between the feedback signal 2100-1, 2100-2, . . . , 2100-N and the analogue payload signal 2000-1, 200-2, . . . , 2000-N and to adjust the predistortion, if necessary. It should be noted that the comparison may be performed with a modified version of the payload signal 2000 and not the payload signal 2000 itself. This will be the case where signal processing has taken place upon the payload signal 2000 prior to the payload signal 2000 leaving the DSP 15. Examples of the signal processing which could take place upon the payload signal 2000 within the DSP 15 include, but are not limited to: filtering, upconversion, crest factor reduction and beamforming processing.

The predistortions are forwarded on a coefficient update path 1010-1, 1010-2, . . . ,1010-N to the predistorter 50-1, 50-2, . . . , 50-N. The predistortion coefficients are fed into the predistorter 50-1, 50-2, . . . , 50-N. There are as many coefficient update paths 1010-1, 1010-2, . . . , 1010-N as predistorters 50-1, 50-2, . . . , 50-N (three are shown on FIG. 1).

With the active antenna 1 of FIG. 1, the predistortion process is an analogue IF process, which may be controlled locally instead of being controlled by a central digital signal processor (DSP) for power amplifier linearization. Additionally, only a set of predistortion coefficients is required for each one of the predistorters 50-1, 50-2, . . . , 50-N instead of a broadband predistortion multiplication process covering the entire wanted spectrum when the predistortion process is undertaken in the central DSP (e.g. as ‘digital baseband predistortion’ or ‘digital IF predistortion).

FIG. 2 shows an example of one of the distortion detection units 100-N that can be used in one aspect of the disclosure. The distortion detection unit 100-N comprises an attenuator 110-N. The attenuator 110-N serves to reduce a power level of the selected one of the feedback signals 2100-N. The attenuator 110-N may be useful to assure that the feedback signal 2100-N does not exceed a power rating of the predistortion coefficient calculation unit 160-N. It should be noted that the attenuator 110-N should be of a substantially linear transfer characteristic over the frequency and power range of transmission of the active antenna array 1. The linear transfer characteristics of the attenuator 110-N prevents further nonlinearities being introduced to the selected one of the feedback signals 2100-N emanating from the attenuator 110-N.

The distortion detection unit 100-N comprises a mixer 120-N receiving a local oscillator signal from a local oscillator 21-N. The combination of the local oscillator 21-N and the mixer 120-N, acting upon an individual one of the feedback signals 1050-1, . . . , 1050-N, is to place the desired part of the distortion spectrum within the pass band of the filter to allow the filter to pass the said distortion and substantially eliminate the original carrier signals. The filter 122-N could be a band-pass filter operating at a suitable intermediate frequency.

The mixer 120-N, the local oscillator 21-N and the filter 122-N form a tuning and filtering unit 123-N. The tuning and filtering unit 123-N tunes the frequency of the feedback signal 2100-N to frequencies containing distortion signal components embedded within the feedback signal 2100-N. The distortion signal components of the feedback signal 2100-N appear adjacent to and between the carriers contained within the feedback signal 2100-N.

The output of the filter 122-N is passed to an energy detector 124-N. The energy detector 124-N could be in the form of a diode, or may be any other known energy detector.

FIG. 3 shows an alternative aspect of the active antenna array 1. The alternative aspect of the active antenna array 1 of FIG. 3 differs from FIG. 1 in that there are two stages of analogue up-conversion upstream of the predistorter 350-1, 350-2, . . . , 350-N instead of a single stage of analogue up-conversion upstream of the predistorter 50-1, 50-2, . . . ,50-N and one stage of analogue up-conversion downstream of the predistorter 50-1, 50-2, . . . ,50-N as shown in FIG. 1. Accordingly, the output of amplifier 37-1, 37-2, . . . , 37-N is passed to the second analogue up-conversion block 52-1, 52-2, . . . , 52-N upstream of the predistorter 350-1, 350-2, . . . , 550-N. The second analogue up-conversion block 52-1, 52-2, . . . ,52-N is adapted to convert the transmit payload signal 2000-1, 200-2, . . . , 200-N from the intermediate frequency range to an RF frequency range. Each one of the up-conversion blocks 52-1, 52-2, . . . , 52-N comprises an up-mixer 55-1, 55-2, . . . , 55-N along with a filter 56-1, 56-2, . . . , 56-N. The up-mixers 55-1, 55-2, . . . , 55-N are known in the art and will not be discussed further within this disclosure. Three signal up-conversion blocks 52-1, 52-2, . . . , 52-N are shown in FIG. 3, all of which are connected to a single local oscillator 550. Having a single local oscillator 550 ensures that the up-converted payload signal on each one of the transmission paths 1005-1, 1005-2, . . . , 1005-N is up-converted coherently.

The output of the up-conversion block 52-1, 52-2, . . . , 52-N is passed to the predistorter 350-1, 350-2, . . . , 350-N. A further difference of the active array antenna 1 of FIG. 3 from that of FIG. 1 is that the predistorter 350-1, 350-2, . . . , 350-N is adapted to work in the radio frequency range.

The output of the predistorter 350-1, 350-2, . . . , 350-N is passed to the RF amplifier 60-1, 60-2, . . . , 60-N, filtered through filter 65-1, 65-2, . . . , 65-N and passed to coupler 70-1, 70-2, . . . , 70-N. The coupler 70-1, 70-2, . . . , 70-N is adapted to extract a portion of the upconverted transmit signal as the feedback signal 2100-1, 2100-2, . . . , 2100-N out of the transmission path 1005-1, 1005-2, . . . , 1005-N.

FIG. 4 shows an alternative aspect of the active antenna array 1. The alternative aspect of the active antenna array 1 of FIG. 4 differs from FIG. 3 in that there is a single up-conversion block 430-1, 430-2, . . . , 430-N, upstream of the predistorter 350-1, 350-2, . . . , 350-N. The up-conversion block 430-1, 430-2, . . . , 430-N comprises an up-mixer 435-1, 435-2, . . . ,435-N along with a filter 436-1, 436-2, . . . , 436-N. The up mixers 435-1, 435-2, . . . , 435-N are known in the art and will not be discussed further within this disclosure. The up-conversion block 430-1, 430-2, . . . , 430-Ns comprises a local oscillator input and receives the local oscillator signal from the local oscillator 438 . Three signal up-conversion blocks 430-1, 430-2, . . . , 430-N are shown, all connected to a single local oscillator 438.

The up-conversion block 430-1, 430-2, . . . , 430-N is adapted to up-convert the payload signal to radio frequency.

FIG. 5 shows an alternative aspect of the active antenna array 1. The alternative aspect of the active antenna array 1 of FIG. 5 differs from FIG. 4 in that the digital-to-analogue converters 20-1, 20-2, . . . , 20-N and the up-conversion block 430-1, 430-2, . . . , 430-N are replaced by a pair of digital-to-analogue converters 529-1, 529-2, . . . , 529-N and a quadrature up-converter 530-1, 530-2, . . . , 530-N supplying RF signals. A local oscillator 538 supplies an oscillator signal to the pair of up-converter mixers 530-1, 530-2, . . . , 530-N, via the quadrature splitter 531-1, 531-2, . . . , 531-N. The digital-to-analogue converters 529-1, 529-2, . . . , 529-N and quadrature splitters 531-1, 531-2, . . . , 531-N can take a number of forms; these are known in the art and will not be explained any further. The output of the pair of digital-to-analogue converters 529-1, 529-2, . . . , 529-N and up-converters 530-1, 530-2, . . . , 530-N is passed to the filter 536-1, 536-2, . . . 536-N in order to remove out of band signals, and then to the predistorter 350-1, 350-2, . . . , 350-N.

FIG. 6 shows an alternative aspect of the active antenna array 1. The alternative aspect of the active antenna array 1 of FIG. 6 differs from the active antenna arrays 1 of FIG. 5 in that the digital-to-analogue converters 529-1, 529-2, . . . , 529-N and up-converters 530-1, 530-2, . . . , 530-N are replaced by delta-sigma digital-to-analogue converters 630-1, 630-2, . . . , 630-N. The delta-sigma digital-to-analogue converters 630-1, 630-2, . . . , 630-N remove the need for an up mixer 35-1, 35-2, . . . ,35-N in the transmission path 30-1, 30-2, . . . , 30-N, as is needed with the digital-to-analogue converters 20-1, 20-2, . . . , 20-N of FIGS. 1, 3-5. It will be apparent that the use of the delta-sigma digital-to-analogue converters 630-1, . . . , 630-N is of interest in order to reduce the system complexity of the radio station 1, as the up mixers are no longer needed.

It will be appreciated that the delta-sigma digital-to-analogue converters 630-1, . . . , 630-N and the digital-to-analogue converters 30-1, . . . , 30-N in combination with the up converters 35-1, . . . , 35-N can be interchanged or used in combination.

FIG. 7 shows an example of one of the polynomial predistorters 50-N that can be used in one aspect of the disclosure. The polynomial predistorter 50-N works at RF frequencies. A predistorter control system 510 is provided for controlling the polynomial predistorter 50-N. The polynomial predistorter 50-N has a signal input 501 for inputting the analogue RF payload signal 2000-N to which the predistortions are to be imposed. The RF payload signal 2000-N has a main frequency F and a width w defined as the difference between a payload signal maximum frequency Fmax and a payload signal minimum frequency Fmin.

The polynomial predistorter 50-N is adapted to work on in-band inter-modulation product non-linearity signal components of the RF payload signal 2000-N. The inter-modulation product non-linearity signal components result from the non linear transfer characteristics of the amplifier 60-N. In the case of a contiguous payload signal 2000-N, the intermodulation product non-linearity signal component of a 3^{rd} order has a 3^{rd} order spectrum centered on the main frequency, F, and having a width of three times the main frequency spectrum width, i.e. 3W. The intermodulation product non-linearity signal component of a 5^{th} order has a 5^{th} order spectrum centered on the main frequency, F and having a width of five times the main frequency spectrum width, i.e. 5W. The intermodulation product non-linearity signal component of a 7^{th} order has a 7^{th} order spectrum centered on the main frequency, F and having a width of seven times the main frequency spectrum width, i.e. 7W. A contiguous payload signal is defined as a signal which has a spectrum in which all of the frequencies are occupied, between its defined minimum frequency and its defined maximum frequency. A single carrier UMTS W-CDMA signal is an example of a contiguous payload signal, as per this definition.

To correct the non linearities the predistorter 50-N imposes predistortions on each ones of the inter-modulation product non linearity signal components. Preferably, two or three inter-modulation product non linearity signal components are used depending on the quality of the predistortion to be achieved. On FIG. 6, three inter-modulation product non linearity signal components 2000-N-3, 2000-N-5, 2000-N-7 are shown which represent respectively the signal component of the non linearity of the cubic order, the signal component of the non linearity of the quintic order, and the signal component of the non linearity of the 7^{th} order. It will be appreciated that as many non linearity orders as needed may be contemplated.

The analogue RF payload signal 2000-N is passed to a splitter 503. The splitter 503 has three outputs 503-1, 503-2, 503-3 for outputting on three paths P1, P2, P3 three duplicated RF payload signal 2000-N. The paths P1, P2, P3 comprises a decomposition system 503′-1, 503′-2, 503′-3 for decomposing the RF payload signal 2000-N into three inter-modulation product non linearity signal components 2000-N-3, 2000-N-5, 2000-N-7 of the RF payload signal 2000-N. Alternately the splitter 503 and three decompositions systems 503′-1, 503′-2, 503′-3 can be replaced by a single splitter decomposition system 503′ outputting the three inter-modulation product non linearity signal components 2000-N-3, 2000-N-5, 2000-N-7.

Decomposition systems 503′-1, 503′-2, 503′-3, or 503′ based on analogue multipliers can be used for the signal decomposition. An example of a splitter and decomposition system 503′ for obtaining the inter-modulation product non linearity signal components of the cubic and quintic orders will be described with reference to FIG. 8.

For a signal emanating from each order of non-linearity of the order n, predistortion is achieved by altering the amplitude using an amplitude predistortion coefficient Cn-A and by altering the phase using a phase predistortion coefficient Cn-P. There are three signal components emanating from three order non linearities 2000-N-3, 2000-N-5, 2000-N-7 and six corresponding predistortion coefficients, C3-P, C3-A , C5-P, C5-P, C7-P and C7-A in the example shown on FIG. 7.

The predistortion coefficients C3-P, C3-A , C5-P, C5-P, C7-P and C7-A are passed on a series of coefficient control lines 502-1, 502-2n. . There is one coefficient control line per coefficient C3-P, C3-A , C5-P, C5-P, C7-P and C7-A. In the example shown on FIG. 7, there are six coefficient control lines. The predistortion coefficients are calculated and updated in the predistortion coefficient calculation unit 160, passed onto the coefficient update path and to the predistorter coefficient control lines 502-1, . . . , 502-2n.

The coefficient control line 502-1, . . . , 502-2n, comprises a memory storage register 503-1, . . . , 503-2n and a low speed digital to analogue converter 504-1, . . . , 504-2n. The function of the memory storage register 503-1, . . . , 503-2n is to store the last predistortion coefficients for the predistorter. The low speed digital to analogue converter 504-1, . . . , 504-2n is adapted to convert the predistortion coefficients outputted digitally from the predistortion coefficient calculation unit 160 into analogue predistortion coefficients. The memory storage register and low speed digital to analogue converter are conventional and will not be discussed further.

The predistorter control system 510 comprises an amplitude controller 506-1, 506-2, 506-3 and a phase controller 507-1, 507-2, 507-3 for each high level order non-linearity. The function of the amplitude controller 506-1, 506-2, 506-3 and the phase controllers 507-1, 507-2, 507-3 is to alter the gain and phase of the signals emanating from non linearity of each order, to produce a predistorted payload signal 2050-1, 2050-2, . . . , 2050-N 507-1, 507-2, 507-3. The phase controllers 507-1, 507-2, 507-3 and amplitude controllers 506-1, 506-2, 506-3 use the respective phase and amplitude predistortion coefficients C3-P, C3-A , C5-P, C5-P, C7-P and C7-A.

The predistorted signal is recomposed within summer 508 adding the different signal components emanating from each order non linearity and outputted in output 505 comprising the predistorted signal 2050-N.

It will be appreciated that the amplitude and phase controls shown could be replaced by a vector modulator without altering the overall system functionality.

Further it is possible to control the predistorter 50-1, 50-2, . . . , 50-N using any other control system.

FIG. 8 shows a detailed view of an example of splitter and decomposition system 503 suitable for decomposing a main signal x having a main signal frequency F into two non linearity signal components x³ and x⁵ of third and fifth orders.

The main signal x is passed to a first splitter S1 having three outputs S1-1, S1-2, S1-3. Each one of the outputs S1-1, S1-2, S1-3 has a frequency equal to the main signal frequency F. Two of the outputs S1-1 and S1-2 are passed to two inputs M1-1 and M1-2 of a first analogue multiplier M1. The first analogue multiplier M1 multiplies the main signal with itself and has one output M1-3 which is a signal x² having a main frequency being twice that of the main signal frequency F.

The signal x² is passed to an input S2-1 of a second splitter S2 having two outputs S2-2, S2-3. The first output S2-2 of the second splitter is passed to a first input M2-1 of a second analogue multiplier M2. The second analogue multiplier M2 has a second input M2-2 for inputting the third output S1-3 of the first splitter S1. The second analogue multiplier M2 multiplies the x² signal from the output M1-3 of the first analogue multiplier M1 with the signal x from the output S1-3 of the splitter S1 and has one output M2-3 which is therefore the signal x³, i.e. the cubic non linearity signal component.

In a similar way, the signal x³ (output M2-3) is passed to an input S3-1 of a third splitter S3 having two outputs S3-2, S3-3. The first output S3-2 of the third splitter S3-1 is passed to a first input M3-1 of a third analogue multiplier M3. The third analogue multiplier M3 has a second input M3-2 for inputting the second output S2-3 of the second splitter S2. The third analogue multiplier M3 has one output M3-3 which is therefore a signal x⁵, i.e. the non linearity signal component.

It will be appreciated that any number of analogue multipliers and splitters can be used depending on the number of harmonic signal components to be obtained. Analogue multipliers can be fabricated using standard Gilbert-cell techniques.

The polynomial lineariser or predistorter may be fabricated as an integrated circuit. This allows obtaining a high degree of accuracy and stability for the generation of the harmonic signal component of different orders—3^{rd}, 5^{th} etc. order non linearity signal component—required to perform linearization.

FIG. 9 shows an overview of the method according to one aspect of this disclosure, wherein the method for linearising can be used in conjunction with the active antenna array of FIG. 1.

In step S1, the payload signal 2000 is converted to the analogue payload signal 2000-1, 2000-2, . . . , 2000-N. The analogue payload signal 2000-1, 2000-2, . . . , 2000-N is forwarded along the transmission path 1005-1, 1005-2, . . . , 1005-N. The analogue payload signal 2000-1, 2000-2, . . . , 2000-N is upconverted into intermediate frequencies and amplified by IF amplifier 37-1, 37-2, . . . , 37-N (step S2)

In step S3, the analogue payload signal 2000-1, 2000-2, . . . , 2000-N is passed to the analogue IF predistorter 50-1, 50-2, . . . , 50-N, wherein predistortion coefficients are imposed onto the analogue payload signal 2000-1, 2000-2, . . . , 2000-N forming the predistorted payload signal 2050-1, . . . , 2050-N. The analogue payload signal 2000-1, 2000-2, . . . , 2000-N is the intended signal to be relayed along the transmission paths 1005-1, 1005-2, . . . , 1005-N. The predistorted payload signal 2050-1, . . . , 2050-N is forwarded along the transmission paths 1005-1, 1005-2, . . . , 1005-N. The imposing of the predistortion comprises adding and/or multiplying “the inverse distortion” to the analogue payload signal 2000-1, 2000-2, . . . , 2000-N.

An up-conversion and filtering of the predistorted payload signal 2050-1, 2050-2, . . . , 2050-N (step S4) follows the step S3 of imposing the predistortions 24-1, . . . , 24-N onto the selected one of the analogue payload signals 2000-1, 2000-2, . . . , 2000-N. The predistorted payload signal 2050-1, 2050-2, . . . , 2050-N is up converted to RF frequencies in second up-conversion block 52-1, 52-2, . . . , 52-N blocks. The filtering may comprise the use of the band pass filter 56-1, 56-2, . . . , 56-N. The band pass filter 56-1, 56-2, . . . , 56-N may comprise a filtering characteristic as defined by the communication protocol.

The method outlined in FIG. 9 is described with two up-conversion stages as shown in FIG. 1. It will be appreciated that this is not limiting and that the method could comprise a single up-conversion stages as required (as known from FIG. 3). It should be further noted that the method is described with a predistorter 50-1, 50-2, . . . , 50-N working at IF frequencies. It will be appreciated that the predistorter could be working in RF frequencies. Any combination of up-conversion and predistorter can be contemplated.

An extraction step S5 comprises the extraction of a feedback signal 2100-1, 2100-2, . . . , 2100-N out of the transmission paths 1005-1, . . . , 1005-N. The extraction step S5 is implemented by a coupler 70-1, . . . , 70-N.

At step S6 the feedback signal 2100-1, 2100-2, . . . , 2100-N is passed to the distortion detection unit 100-1, 100-2, . . . , 100-N in order to detect a level of residual distortion in the feedback signal 2100-1, 2100-2, . . . , 2100-N.

The detection of the level of residual distortion comprises an attenuation step S7 in order to adapt a power level of the selected one of the feedback signal 2100-1, 2100-2, . . . , 2100-N to a power level accepted by the digital predistortion coefficient calculation unit 160-1, 160-2, . . . , 160-N. The attenuation of the feedback signals 2100-1, 2100-2, . . . , 2100-N may be achieved by attenuators 110-1, 110-2, . . . , 110-N.

The feedback signals 2100-1, 2100-2, . . . , 2100-N are passed to the tuning and filtering unit 123-1, 123-2, . . . 123-N at step S8. The tuning and filtering unit 123-1, 123-2, . . . 123-N is adapted to tune the frequency of the feedback signals 2100-1, 2100-2, . . . , 2100-N, and to filter the out-of band signals. The output of the tuning and filtering unit 123-1, 123-2, . . . 123-N is the power amplifier's output distortion signal component contained within the feedback signal 2100-1, 2100-2, . . . , 2100-N. For example the output of the tuning and filtering unit 123-1, 123-2, . . . 123-N could be a distortion signal component relating to the intermodulation product non-linearity signal component of the cubic order present in the power amplifier's input-output transfer characteristic. An iterative process of linearization may be implemented, wherein different adjacent channel frequencies, broadly corresponding to signal components emanating from non linearities of different order, are used in each step of the iterative process.

The tuning and filtering step S8 is followed by a energy detection step S9, and the detected signal is passed to the predistorter coefficient calculation unit 160-1, 160-2, . . . , 160-N, where the predistorter coefficient calculation unit 160-1, 160-2, . . . , 160-N may compile new predistortion coefficients for the selected one of the transmission paths 1005-1, 1005-2, . . . , 1005-N (step S10).

The predistorter coefficient calculation unit 160-1, 160-2, . . . , 160-N iterates the predistortion coefficients, based upon the differences between the feedback signal 2100-1, 2100-2, . . . , 2100-N and the payload signal 2000. The extraction step S10 yields the differences mainly introduced due to the nonlinearities of the amplifier 60-1, 60-2, . . . , 60-N. The differences may comprise a difference in amplitude and/or phase between the payload signal and the selected one of the feedback signals 2100-1, 2100-2, . . . , 2100-N. Methods and devices for extracting the differences between two signals are known in the art and shall not be further explained here.

The new updated predistortion coefficients are passed onto the coefficient update path 1010-1, 1010-2, . . . , 1010-N, to the predistorters 50-1, 50-2, . . . , 50-N (step S11).

An iterative process of linearization may be implemented, wherein different distortion signal components such as the intermodulation product non linearity signal components of different orders are used in each step of the iterative process. For example in a first step of the linearization process, the distortion detection unit 100-1, 100-2, 100-2, . . . , 100-N may detect the residual distortion of the intermodulation product non linearity signal component of the cubic order. In a second iterative step of the linearization process, the distortion detection unit may detect the residual distortion of the intermodulation product non linearity signal components of the quintic order. In a third iterative step of the linearization process, the distortion detection unit may detected the residual distortion of either of the intermodulation product non linearity signal component of the 7^{th} order or the residual distortion of the intermodulation product non linearity signal component of the cubic order. Any iterative process can be implemented.

The disclosure further relates to a computer program product embedded on a non-transitory computer readable medium. The computer program product comprises executable instructions for the manufacture of the active antenna array 1 according to the present invention.

The disclosure relates to yet another computer program product. The yet another computer program product comprises instructions to enable a processor to carry out the method for digitally predistorting a payload signal 2000 according to the invention.

While various embodiments of the present invention have been described above, it should be understood that they have been presented by way of example, and not limitation. It will be apparent to persons skilled in the relevant arts that various changes in form and detail can be made therein without departing from the scope of the invention. In addition to using hardware (e.g., within or coupled to a central processing unit (“CPU”), micro processor, micro controller, digital signal processor, processor core, system on chip (“SOC”) or any other device), implementations may also be embodied in software (e.g. computer readable code, program code, and/or instructions disposed in any form, such as source, object or machine language) disposed for example in a non-transitory computer useable (e.g. readable) medium configured to store the software. Such software can enable, for example, the function, fabrication, modelling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known non-transitory computer useable medium such as semiconductor, magnetic disc, or optical disc (e.g., CD-ROM, DVD-ROM, etc.). The software can also be disposed as a computer data signal embodied in a non-transitory computer useable (e.g. readable) transmission medium (e.g., carrier wave or any other medium including digital, optical, analogue-based medium). Embodiments of the present invention may include methods of providing the apparatus described herein by providing software describing the apparatus and subsequently transmitting the software as a computer data signal over a communication network including the internet and intranets.

It is understood that the apparatus and method describe herein may be included in a semiconductor intellectual property core, such as a micro processor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

### LIST OF REFERENCE NUMERALS

15 digital signal processor (DSP)
20-1, 20-2, . . . , 20-N digital-to-analogue conversion block
28-1, 28-2, . . . , 28-N. first filter
30-1, 30-2, . . . ,30-N up-conversion block
35-1, 35-2, . . . , 35-N up-mixer
36-1, 36-2, . . . , 36-N filter
37-1, 37-2, . . . , 37-N. amplifier
38 local oscillator
50-1, 50-2, . . . , 50-N predistorter
60-1, 60-2, . . . , 60-N RF amplifier
65-1, 65-2 . . . , 65-N filter
70-1, . . . , 70-N. coupler
95-1, . . . , 95-N antenna elements
100-1, 100-2, . . . , 100-N distortion detection unit
110-1, 110-2, . . . , 110-N attenuator
120-1, 120-2, . . . , 120-N mixer
21-1, 21-2, . . . 21,-N oscillator
122-1, 122-2, . . . ,122-N filter
123-1, 123-2, . . . , 123-N energy detector
160-1, 160-2, . . . , 160-N predistorter coefficient calculation unit
430-1, 330-2, . . . , 330-N up-conversion block
435-1, 335-2, . . . , 335-N up-mixer
436-1, 336-2, . . . , 336-N filter
438 a local oscillator
350-1, 350-2, . . . , 350-N predistorter
529-1, 529-2, . . . , 529-N digital to analogue converter
530-1, 530-2, . . . , 530-N up-converter
531-1, 531-2, . . . , 531-N quadrature splitter
538 local oscillator
630-1, 630-2, . . . , 630-N Delta-sigma digital-to-analogue converters
510 Predistorter control system
506-1, 506-2, 506-3 amplitude controller
507-1, 507-2, 507-3 phase controller
C3-P, C3-A , C5-P, C5-P, . . . Cn-P and Cn-A predistortion coefficients coefficient control line 502-1, . . . 502-2n
503 splitter
503′-1, 503′-2, 503′-3 decomposition system
S1, S2, S3 splitter
M1, M2, M3: analogue multipliers
504-1 input
504-2, 504-3
S1-1, S1-2, S1-3 1^{st} splitter outputs
S2-1 2^{nd} splitter input
S2-2, S2-3 2^{nd} splitter outputs
S3-1 3^{rd} splitter input
S3-2, S3-3 3^{rd} splitter outputs
M1-1, M1-2 1^{st} analogue multiplier inputs
M1-3 1^{st} analogue multiplier output
M2-1, M2-2 2^{nd} analogue multiplier inputs
M2-3 2^{nd} analogue multiplier output
M3-1, M3-2 3rd analogue multiplier inputs
M3-3 3rd analogue multiplier output

Paths
1000-1, 1000-2, . . . , 1000-N antenna path
1005-1, 1005-2, . . . , 1005-N transmission path
1010-1, 1010-2, 1010-N coefficient update path
1050-1, 1050-2, . . . , 1050-N feedback path

Signals
2000 Payload signal
2000-1, . . . 2000-N, payload transmit signal
2050-1, 2050-2, . . . ,2050-N predistorted payload signal
2100-1, 2100-2, . . . , 2100-N Feedback signal
2000-N-3, 2000-N-5, 2000-N-7 distortion signal component

1. An active antenna array comprising:
a digital signal processor connected to a plurality of digital-to-analogue conversion blocks;
a plurality of antenna elements;
a plurality of transmission paths, whereby an individual one of the plurality of transmission paths is connected between an individual one of the plurality of digital-to-analogue conversion blocks and an individual one of the plurality of antenna elements, whereby an individual one of the plurality of transmission paths comprises a predistorter and a coupler;
a plurality of feedback paths connected between an individual one of the couplers and an individual one of the predistorters, wherein an individual one of the plurality of feedback paths comprises a predistorter coefficient calculation unit.

2. The active antenna array of claim 1, further comprising a distortion detection unit configured to detect a level of residual distortion in an output signal on an individual one of the plurality of transmission paths, wherein the distorter detection unit is connected to the predistorter coefficient calculation unit.

3. The active antenna array of claim 1, wherein the digital to analogue conversion block is one of a digital-to-analogue converter, a delta-sigma digital-to-analogue converter or a pair of digital-to-analogue converters supplying I & Q signals.

4. The active antenna array of claim 1, further comprising a predistorter control system for controlling the predistorter.

5. The active antenna array of claim 4, wherein the predistorter control system comprises at least one of an amplitude controller and a phase controller.

6. The active antenna array of claim 5, wherein the amplitude controller is adapted to control an amplitude of at least one distortion signal component emanating from an intermodulation product non-linearity.

7. The active antenna array of claim 5, wherein the phase controller is adapted to control a phase at least one distortion signal component emanating from an intermodulation product non-linearity.

8. The active antenna array of claim 1, wherein the predistorter comprises a splitter and decomposition system adapted for decomposing an input signal into at least two distortion signal components.

9. The active antenna array of claim 7, wherein the decomposition system comprises at least one of an analogue multiplier and of a splitter,

10. The active antenna array of claim 7, wherein the predistorter further comprises a summer for adding the at least two distortion signal components.

11. A method for predistortion of radio signals comprising:
predistorting one or more of a plurality of analogue payload signals, thereby obtaining at least one predistorted payload signal,
amplifying the at least one predistorted payload signal,
extracting a portion of the at least one predistorted payload signal as a feedback signal, and
adapting the predistorting of the analogue payload signal by comparing the feedback signal with at least one of the one or more of the plurality of analogue payload signals.

12. The method for predistortion of radio signals according to claim 11, comprising detecting a level of residual distortion in an output signal on an individual one of the plurality of transmission paths.

13. The method for predistortion of radio signals according to claim 12, further comprising iteratively detecting a level of residual distortion in an output signal on an individual one of the plurality of transmission paths.

14. The method for predistortion of radio signals according to claim 13, wherein the output signal comprises at least one distorsion signal component.

15. The method for predistortion of radio signals according to claim 12, further comprising setting at least one of an amplitude controller and a phase controller in order to reduce the detected level of the residual distortion

16. A computer program product comprising a non-transitory computer-usable medium having control logic stored therein for causing a computer to manufacture an active antenna array for a mobile communications network, the active array antenna comprising:
a digital signal processor connected to a plurality of digital-to-analogue conversion blocks;
a plurality of antenna elements;
a plurality of transmission paths, whereby an individual one of the plurality of transmission paths is connected between an individual one of the plurality of digital-to-analogue conversion blocks and an individual one of the plurality of antenna elements, whereby an individual one of the plurality of transmission paths comprises a predistorter and a coupler;
a plurality of feedback paths connected between an individual one of the couplers and an individual one of the predistorters, wherein an individual one of the plurality of feedback paths comprises a predistorter coefficient calculation unit.

17. A computer program product comprising a non-transitory computer-usable medium having control logic stored therein for causing an active antenna to execute a method for receiving a plurality of individual radio signals comprising:
first computer readable code means for predistorting one or more of a plurality of analogue payload signals, thereby obtaining at least one predistorted payload signal;
second computer readable code means for amplifying the at least one predistorted payload signal;
third computer readable code means for extracting a portion of one or more of the at least one predistorted payload signal as a feedback signal
fourth computer readable control means for adapting the predistorting of the one or more of the plurality of analogue payload signals by comparing the feedback signal with at least one of the one or more of the plurality of analogue payload signals.
